(19) United States
(12) Patent Application Publication
(10) Pub. No.: US 2010/0031892 A1
(43) Pub. Date: Feb. 11, 2010

(54) METHOD FOR STORAGE OF LIVE CRUSTACEANS

(76) Inventors: Ilya Y. Ilyin, Wayland, MA (US); Maria G. Tkachman, St. Petersburg (RU); Maria E. Urusova, Gatchina (RU); James S. Jones, St. Simons Island, GA (US); William E. Grieshober, East Amherst, NY (US); Semyon Kogan, Newton, MA (US); Pavel Butylin, St. Petersburg (RU); Rostislav Khorenyan, St. Petersburg (RU); Yuri Punin, St. Petersburg (RU); Alexander Shumeev, St. Petersburg (RU)

Correspondence Address: HODGSON RUSS LLP;THE GUARANTY BUILDING, 140 PEARL STREET, SUITE 100, BUFFALO, NY, 14202-4040, US

(21) Appl. No.: 12/498,915

(22) Filed: Jul. 7, 2009

Related U.S. Application Data
(60) Provisional application No. 61/078,595, filed on Jul. 7, 2008.
(60) Provisional application No. 61/170,408, filed on Apr. 17, 2009.

(51) Int. Cl. A01K 61/00

(52) U.S. Cl. 119/207; 119/214

(57) ABSTRACT

Provided is a method for storage of live crustaceans. The method is performed by causing the live crustacean to enter into an anesthetized state by exposing the crustacean to a combination of xenon and oxygen, cooling the anesthetized live crustacean to a temperature of 1° C. to 10° C. to cause the crustacean to enter into a state of anabiosis, and storing the live crustacean in the state of anabiosis under ambient pressure at 1° C. to 10° C. under from 90% to 100% humidity. Also provided is a container containing a plurality of live crustaceans that are in a state of anabiosis via performance of the method.

This application claims priority to U.S. application No. 61/078,595, filed Jul. 7, 2008, and U.S. application No. 61/170,408, filed Apr. 17, 2009, the disclosures of each of which are hereby incorporated by reference.

### FIELD OF THE INVENTION

The present invention relates generally to the field of treatment and storage of live organisms, and more particularly to storage of living crustaceans that are intended for human consumption.

### BACKGROUND OF THE INVENTION

Crustacean meat has a short shelf life and if it is not contained properly will quickly spoil. On average, refrigerated crustaceans, such as shrimp, lobsters and crabs, have a shelf life of one to two days, but if frozen, can last for several months. For this reason, many types of crustaceans are often fully cooked, optionally shucked, and frozen before being transported to a place where they are sold to consumers. However, reheating the meat at its final destination can alter its taste and the meat may become odorous, tough and overall less appealing. Therefore, it is preferable to keep crustaceans intended for human consumption in a living state for as close as possible to the time when they are to be consumed. Currently, live crustaceans are typically transported on ice in boxes or crates. However, since crustacean's gills must be kept wet for them to respire, they can survive for only a matter of hours in such a state.

If the crustaceans are instead transported alive in tanks of water, which are very heavy and increase transportation costs, some or all of the crustaceans in the tanks often die suddenly after only a few days. Further, crustaceans frequently become aggressive and kill one another while kept in the tanks. Thus, there is an ongoing need for improved methods of preserving living crustaceans so that they can be stored or transported during longer periods of time than currently available methods permit.

### SUMMARY OF THE INVENTION

The present invention provides a method for preparing a live crustacean for storage. The method comprises the general steps of: i) causing the live crustacean to enter into an anesthetized state by exposing the crustacean to a combination of xenon and oxygen; ii) cooling the anesthetized live crustacean to a temperature of from 1° C. to 10° C. to cause the crustacean to enter into a state of anabiosis; and iii) storing the live crustacean in the state of anabiosis at 1° C. to 10° C. under from 90% to 100% humidity.

While the live crustacean is entering into an anesthetized state (a state wherein the heart beat rate of the crustacean has been lowered to below 80% of its normal heart beat rate, but is higher than 20% of its normal heart beat rate), it may be partially or fully submerged in an aqueous medium. The aqueous medium may be in a container that also contains an atmosphere that comprises the combination of xenon and oxygen. In the combination of oxygen and xenon, the partial pressure of oxygen is from 0.2 to 1 bar, the partial pressure of xenon is from 1 to 1.8 bars, and the sum of the partial pressure of oxygen and the partial pressure of xenon is from 1.2 to 2 bars. The total pressure of the atmosphere may be greater than 2 bars. For example, a mixture of xenon and oxygen having a total partial pressure of 2 bars can be introduced into a container that has a headspace containing ordinary air at a pressure of 1 bar, thereby yielding a total pressure of 3 bars for the atmosphere in the container.

The combination of xenon and oxygen can be circulated through the aqueous medium to expose the crustacean to xenon and oxygen dissolved in the aqueous medium, thereby causing the crustacean to enter into an anesthetized state. The crustacean can be exposed to the oxygen and xenon in the aqueous medium at ambient temperatures for a period of from one to six hours.

Prior to, during, or after removing the aqueous medium from the container, the anesthetized live crustacean is cooled to a temperature of 1° C. to 10° C. in an atmosphere that has a partial pressure of oxygen from 0.2 to 1 bar, a partial pressure of xenon of from 1 to 1.8 bars, and a sum of the partial pressure of oxygen and the partial pressure of xenon from 1.2 to 2 bars.

The live crustacean may be held at a temperature of from 1° C. to 10° C. under the pressurized atmosphere for a period of time sufficient to cause the crustacean to enter a state of anabiosis (having a heart beat rate that is 20% or less than the normal heart beat rate of the crustacean, but wherein the crustacean remains alive). In one embodiment, the crustacean is held at a temperature of from 1° C. to 10° C. under a pressurized atmosphere for 3 to 24 hours.

Subsequent to causing the crustacean to enter a state of anabiosis, the pressure under which the crustacean may be held is adjusted to ambient pressure, which can be performed by equilibrating the atmosphere in the container with ambient atmosphere. The crustacean may then be stored in a storage container in a state of anabiosis at 1° C. to 10° C., wherein the storage container exposes the crustacean to from 90% to 100% humidity. The crustacean can remain alive in the storage container for at least 4 days, and up to 14 days, or more.

The invention is expected to be useful for preservation and storage of any crustacean, but is particularly useful for crustaceans that typically dwell in warm waters. In particular embodiments, crustaceans treated using the method of the invention can include crabs, lobsters, crawfish, shrimp, and combinations thereof.

The invention also provides a container comprising a plurality of live crustaceans. The plurality of live crustaceans are present in the container containing an atmosphere comprising oxygen and xenon. In one embodiment, oxygen in the atmosphere in the container has a partial pressure of from 0.2 to 1 bars, partial pressure of xenon in the atmosphere of the container is from 1 to 1.8 bars, and the sum of the partial pressure of oxygen and the partial pressure of xenon in the atmosphere of the container is from 1.2 to 2 bars, and wherein the temperature in the container is from 2-10° C. The container may contain any crustaceans, including but not limited to crabs, lobsters, crawfish, shrimp and combinations thereof.

### BRIEF DESCRIPTION OF THE FIGURES

FIG. 1 provides a graphical representation of heart beat rate profiles of crawfish prior to initiation of the method of the invention (panel A), while the crawfish is held in an atmosphere comprising oxygen and xenon (panel B), about one minute after equilibration of the atmosphere in the container with ambient atmosphere and at reduced temperature (panel C), and after 4 days of storage (panel D).

FIG. 2 provides a graphical representation of practicing the method of the invention in containers containing a plurality of crawfish, as compared to a control not treated with an atmosphere comprising oxygen and xenon.

### DETAILED DESCRIPTION OF THE INVENTION

The present invention provides a method for preservation and storage of living crustaceans. The method is based on our discovery that subjecting the crustaceans to an atmosphere comprising oxygen and xenon in certain ratios for particular periods of time, along with refrigeration temperatures, unexpectedly causes the crustaceans to pass through an anesthetized state and into a state of anabiosis such that they can be stored alive at refrigerated temperatures in a humid environment for at least 14 days, but without being submerged in an aqueous medium.

It is considered that a crustacean is in an anesthetized state when its heart beat rate has been lowered to below 80% of its normal heart beat rate, but is higher than 20% of its normal heart beat rate. It is considered that the term “anabiosis” refers to a state of a living crustacean having a heart beat rate that is 20% or less than the normal heart beat rate of the crustacean. In one embodiment, the heart beat rate of a crustacean in anabiosis is from the 20% to 12% of the normal heart beat rate of the crustacean.

The normal heart beat rate of any particular type of crustacean will either be known to those skilled in the art, or can be determined using conventional techniques, such as by measuring the heart beat rate of the crustacean using a heart beat rate monitor. Generally, the normal heart beat rate of crustaceans ranges according to body weight. For example, a crustacean with a body weight of 5 grams will generally have a normal heart beat rate of about 200 beats per minute. A crustacean with a body weight of 500 grams will generally have a normal heart beat rate of about 70 beats per minute. In particular examples presented herein to illustrate the invention, cherax crawfish (Cherax papuanus) having a body weight that ranged from 10-15 grams are used. Cherax crawfish have a normal heart beat rate of about 115 beats per minute. However their heart beat rates can reach 175 beats per minute when they become agitated. The skilled artisan will be able to control for such variations during experimental manipulation of crustaceans such that a normal heart beat rate for any particular crustacean can be determined, and therefore heart beat rates that signify an anesthetized state and a state of anabiosis can also be identified. We have accordingly determined that performing the method of the invention can be used to reduce the heart beat rate of living crustaceans to below 20% of the normal heart beat rate of the crustaceans, after which the crustacean can be held in a living state in a storage container at refrigerated temperatures for at least 4 days, and for up to 14 days, or more, without being submerged in an aqueous medium.

The method of the invention generally comprises the steps of: i) causing the live crustacean to enter into an anesthetized state by exposing the crustacean to a combination of xenon and oxygen; ii) cooling the anesthetized live crustacean to a temperature of from 1° C. to 10° C. to cause the crustacean to enter into a state of anabiosis; and iii) storing the live crustacean in the state of anabiosis at 1° C. to 10° C. under from 90% to 100% humidity.

In one embodiment, the combination of xenon and oxygen is present in an atmosphere under which the crustaceans are held at a higher than ambient pressure. Ambient pressure at sea level is 1013.2 millibars, but can vary according to location. “Ambient pressure” therefore refers to the pressure of the atmosphere surrounding the crustacean once the increased pressure under which the crustacean is held is released. It is therefore considered that the ambient pressure is equivalent to the ambient pressure at the physical location (i.e., ambient pressure in a room) where the crustacean is being prepared for storage. “Ambient atmosphere” means the composition of the atmosphere at a physical location (i.e., the composition of air in a room where the crustacean is being processed).

Causing the live crustacean to enter into an anesthetized state is performed by holding the live crustacean partially or fully submerged in an aqueous medium, such as water. The aqueous medium can be contained in a container that comprises an atmosphere in the headspace of the container. The container can be any suitable container that is capable of containing an aqueous medium and an atmosphere, such as tank, a chamber, a barrel, a drum, etc. The container is preferably capable of maintaining gas-tight conditions.

In arriving at the present invention, we discovered that the atmosphere comprising xenon and oxygen can be pressurized, and the sum of the partial pressure of xenon and oxygen in the atmosphere in the container in which the crustaceans are treated should not exceed 2 bars. At total xenon plus oxygen pressures above 2 bars, the crustaceans experience erratic heart beat rates and do not achieve a state of anabiosis. This discovery was surprising because, when an atmosphere such as ordinary air is used to subject living crustaceans to pressures well above 2 bars, they do not experience erratic heart beats. In particular, we have determined that the method can be performed using an atmosphere wherein the partial pressure of oxygen is from 0.2 to 1 bar, the partial pressure of xenon is from 1 to 1.8 bars, and the sum of the partial pressure of oxygen and the partial pressure of xenon in the atmosphere is from 1.2 to 2 bars. The total pressure of the atmosphere may be higher, such as up to 3 bars in the case where the combination of xenon and oxygen is added to a container having an initial pressure of 1 bar (ambient pressure), provided the relative amounts and pressures of oxygen and xenon are within the aforementioned parameters.

While causing the live crustacean to enter into an anesthetized state, it is preferable to circulate the atmosphere comprising the xenon and the oxygen through the aqueous medium in the container at ambient temperature. “Ambient temperature” means the temperature of the physical location (i.e., room temperature) where the crustacean is being prepared for storage. In certain embodiments, ambient temperature is from 18° C. to 26° C., including all integers there between, and all numbers between consecutive integers to the tenth decimal point. In a particular embodiment, ambient temperature is 23° C.

The atmosphere can be bubbled through the aqueous medium using any suitable device, system, or apparatus. It is preferable that the circulation of the atmosphere through the aqueous medium be performed using a closed system such that the pressure to which the crustaceans are exposed can be maintained.

The aqueous medium in which the crustacean is held can be any aqueous medium in which the crustacean can respire. Non-limiting examples of types of aqueous media include fresh water, salt water, brackish water, combinations thereof, or distilled water, or partially of fully purified water. In one embodiment, the aqueous medium is the same or similar to the aqueous medium in which the crustacean ordinarily lives. For instance, if the crustacean is a shrimp obtained from a shrimp farm, water from the shrimp farm may be used as the aqueous medium. Alternatively, an aqueous medium having the same or similar composition to water in the shrimp farm can be prepared. Thus, in various embodiments, the composition of the aqueous medium could be adjusted for pH, mineral content, and other compositions of matter that are typically dissolved or suspended in the aqueous medium in which the crustacean ordinarily lives. The aqueous medium could also be adjusted to lack components of the aqueous medium that are deleterious to the crustacean, or would not be desired during performance of the method of the invention, such as waste products or other components that will be recognized by those skilled in the art as undesirable for inclusion in the aqueous medium and/or during storage.

The live crustacean can be held in the aqueous medium under the atmosphere comprising oxygen and xenon at ambient temperature for any period of time sufficient for the live crustacean to enter into an anesthetized state. In one embodiment, the atmosphere is pressurized, and the period of time sufficient for the live crustacean to enter into an anesthetized state is from one to six hours. In a particular embodiment, the period of time sufficient for the live crustacean to enter into an anesthetized state is 2.5 hours.

After the live crustacean has entered into an anesthetized state, the crustacean is cooled to a temperature of from of 1° C. to 10° C., and including all integers there between, and all numbers between consecutive integers to the tenth decimal point (i.e., 1.1, 1.2, 1.3° C., etc.). The cooling can be performed prior to, during, or after removing the aqueous medium from the container. Cooling the crustacean can be performed by using any suitable cooling method and/or device or system. For example, in one embodiment, the cooling is performed by holding the crustacean in a container under that has efficient thermal exchange properties so that the crustacean inside the container can be cooled by placing the container in a chilled or refrigerated environment. Alternatively, the container may be operably connected to a refrigeration source that is capable of reducing the temperature of the atmosphere inside the container, thereby cooling the crustacean.

In one embodiment, the cooling of the anesthetized live crustacean to a temperature of from 1° C. to 10° C., including all integers there between, and all numbers between consecutive integers to the tenth decimal point, is performed after removal of the aqueous medium from the container. The aqueous medium can be removed from the container by any suitable method. The container can be adapted to permit drainage of the aqueous medium. For example, the container may comprise a drain component, such as a valve or removable plug for aqueous medium removal. The drain component is preferably configured on the bottom or side of the container near its bottom to facilitate removal of all or most of the aqueous medium without having to open the container cover. Alternatively, the aqueous medium could be removed from the container by pouring or by aspiration.

During or after removal of the aqueous medium, the atmosphere in the container may be adjusted such that it comprises oxygen and xenon where the partial pressure of oxygen in the atmosphere is from 0.2 to 1 bar, the partial pressure of the xenon in the atmosphere is from 1 to 1.8 bars, and the sum of the partial pressure of oxygen and the partial pressure of xenon in the atmosphere is from 1.2 to 2 bars. The live crustacean can then be held at the temperature of from 1° C. to 10° C. under the pressurized atmosphere comprising xenon and oxygen for a period of time sufficient for the crustacean to enter into a state of anabiosis. The period of time sufficient to cause the crustacean to enter into a state of anabiosis can vary, depending on the type and size of the crustacean, and can be determined by those skilled in the art, given the benefit of the present invention. In this regard, and without being bound by any particular theory, it is believed that by maintaining the crustacean in an atmosphere at a temperature of from 1-10° C., wherein the atmosphere comprises oxygen and xenon, which may have a partial pressure of the oxygen from 0.2 to 1 bar, a partial pressure of the xenon from 1 to 1.8 bars, and a sum of oxygen partial pressure and xenon partial pressure from 1.2 to 2 bars, an amount of the xenon in the atmosphere sufficient to cause the crustacean to enter anabiosis will dissolve into the tissues of the crustacean. This is considered to be due at least in part to the presence of oxygen in the atmosphere in the container, which permits the crustacean to engage in aerobic respiration while held in the container. It is considered that respiration delivers xenon to all or most of the crustacean body tissues, causing the tissues of the live crustacean to become saturated with xenon, which results in the state of anabiosis.

In one embodiment, the period of time sufficient for the crustacean to enter into the state of anabiosis is from 3 to 24 hours, including all integers there between, and all numbers between consecutive integers to the tenth decimal point. In particular embodiments, the period of time sufficient to cause the crustacean to enter into a state of anabiosis is 15, 16, 17, 18, 19, 20, 21, 22, 23, or 24 hours, or longer. In one embodiment, the temperature of the atmosphere while the crustacean being brought into a state of anabiosis is 6° C., the xenon is present at a partial pressure of 1.1 bars, the oxygen is present at a partial pressure of 0.3 bars, the total pressure of the atmosphere in the container is 2.4 bars, and the crustacean is in a state of anabiosis after 20 hours.

Subsequent to holding the live crustacean at the temperature of from 1° C. to 10° C. for a period sufficient for the crustacean to enter anabiosis, pressure in the container can be equilibrated to ambient pressure. “Ambient pressure” refers to the pressure of the atmosphere surrounding the crustacean once the experimentally increased pressure in the container is released. It is therefore considered that the ambient pressure of the atmosphere in the container is equivalent to the ambient pressure at the physical location where the method is being performed (i.e., ambient pressure in the room or place where the method is being performed). Once the pressure in the container is equilibrated to ambient pressure, the composition of the atmosphere in the container may be the same as the ambient atmosphere (i.e., the composition of the atmosphere in the room where the method is being performed). In one embodiment, the pressure in the container is equilibrated with ambient pressure by releasing gas from the container at a rate of from 0.2-0.05 bars/minute.

After the pressure in the container has been reduced to ambient pressure, the crustacean can transferred to a storage container. Alternatively, the same container in which the crustacean was brought into anabiosis can be used as the storage container. The crustacean is held in the storage container at a temperature of from 1-10° C. in high humidity. The humidity in the container is from 90% to 100% humidity, including all integers there between, and all numbers between consecutive integers to the tenth decimal point. It is preferable to maintain 100% humidity in the storage container. Humidity can be maintained by providing a reservoir of water in the container, wherein the water in the reservoir can contribute to maintenance of the humidity in the storage container. For example, the storage container can contain water in a reservoir in the form of a wet material, such as a sponge, a paper-based material, or any other material capable of holding water that can contribute to maintenance of humidity in the container. Alternatively, water can be provided to the interior of the container by spraying, misting, and the like. In one embodiment, the crustacean is not submerged in an aqueous medium in the container.

The crustacean can remain alive in the storage container for at least 4 days, and preferably for from 4 days to 14 days, including all integers there between, and all numbers between consecutive integers to the tenth decimal point, or more days. The temperature of the crustacean in the storage container can be kept at 1-10° C. including all integers there between, and all numbers between consecutive integers to the tenth decimal point, using any suitable method, device or system. In one embodiment, the container has efficient thermal exchange properties and can be kept in a refrigerated environment so as to maintain the temperature inside the container (and thereby the temperature of the crustacean in the container) at from 1° C.-10° C. In one embodiment, the temperature is held at 6° C.

The storage container can be any container suitable for holding the live crustacean. The storage container can be reversibly sealable, and can be a container suitable for transferring the crustacean to a point of sale to a consumer, such as a fish market, grocery store, restaurant, and the like. The storage container is preferably of a size capable of holding a plurality of crustaceans.

The invention is expected to be useful for preservation and storage of any living crustacean, and is particularly useful for crustaceans that ordinarily dwell in relatively shallow, warm fresh or warm salt waters.

In particular embodiments, the method is used for preservation of members of the Malacostraca class of Crustacea. In this regard, it is understood that all malacostracans have an open circulatory system that is more complex than that found in other crustaceans. For example, they have a single-chambered heart which is surrounded by a pericardial sinus. In particularly preferred embodiments, the method is used for preservation of members of the order Decapoda, which includes decapods, such as crabs, lobsters, crawfish (crawfish are also referred to in the art as “crayfish” and “crawdads”) and shrimp. In decapods, the heart is a compact box-shape with one or two ostia located in the thorax. The blood, sometimes referred to as hemolymph, is pumped to the head through an aorta and to gills and appendages through lateral and ventral arteries. However, veins are not present, and blood returns to the heart through a series of sinuses. (See “malacostracan” in Encyclopaedia Britannica (2009)). We performed experiments (as further described herein) using cherax crawfish (Cherax papuanus) as a model crustacean. It is expected that the model cherax crawfish provides a basis for predicting the effects the method of the invention will have on other, anatomically similar crustaceans, at least insofar as the method could be adapted for use with other such crustaceans without undue experimentation.

With respect to performance of the method of the invention on shrimp, it will be recognized that, while shrimps and prawns belong to different suborders of Decapoda, they are very similar in appearance, and in commercial fisheries, the terms “prawn” and “shrimp” are often used interchangeably. The term “shrimp” as used herein is accordingly intended to encompass prawns and shrimp. The invention is expected to be useful for preservation and storage of any shrimp. Some non-limiting examples of the types of shrimp suitable for preservation and storage using the method of the invention include Pacific white shrimp (Litopenaeus vannamei), Giant tiger prawn (P. monodon, also known as “black tiger shrimp”), Western blue shrimp (P. stylirostris), Chinese white shrimp (P. chinensis, also known as the fleshy prawn), Kuruma shrimp (P. japonicus), Indian white shrimp (P. indicus) and Banana shrimp (P. merguiensis). The method of the invention is also expected to be useful for preservation and storage of any type of crawfish. In various non-limiting embodiments, the crustacean is a crawfish selected from red swamp crawfish (P. clarkii), and Cherax papuanus. The invention may be performed on one, or more than one crustacean, and includes performing the method on combinations of distinct crustaceans types.

The method can be used with crustaceans removed from natural habitats, such as an ocean, bay, sea, running fresh water tributaries, such as rivers or streams, bodies of fresh water, such as ponds or lakes, or from man-made habitats, such as aqua-farms, including but not limited to shrimp farms.

In one embodiment, the invention can be used to preserve live shrimp obtained from shrimp farm growout ponds, in which the shrimp are grown from juveniles to commercially marketable sizes.

It will be recognized from the foregoing that, in another embodiment, the invention comprises a container comprising at least one crustacean, wherein the container contains an atmosphere comprising oxygen and xenon. The atmosphere may be pressurized such that the partial pressure of the oxygen in the container is from 0.2 to 1 bar, the partial pressure of the xenon in the container is from 1 to 1.8 bars, and the sum of the partial pressures of xenon and oxygen in the container is from 1.2 to 2 bars. The temperature in the container may be from 1-10° C., including all integers there between, and all numbers between consecutive integers to the tenth decimal point. The storage container may have any or all of the characteristics as the container described herein for use in bringing the crustacean into a state of anabiosis. In one embodiment, the container comprises a plurality of crustaceans. In particular embodiments, the crustaceans are selected from crabs, lobsters, crawfish, shrimp, and combinations thereof.

The following Examples are intended to illustrate, but not limit the invention.

### EXAMPLE 1

This Example provides a demonstration of storing a crawfish in a state of anabiosis by performing the method of the invention. In order to monitor the heart beat rate, cardio sensors were fixed on the shells of cherax crawfish (Cherax papuanus). For this Example, one crawfish per chamber was used. A total of 50 experiments were performed. In each case, the crawfish were placed in a 1.5 liter chamber containing 1.2 liters of water. The chamber was hermetically sealed and the atmosphere in the container was adjusted by introducing xenon up to a partial pressure of 1.1 bar and oxygen (O₂) up to a partial pressure of 0.3 bar, yielding a total pressure in the headspace of the container of 2.4 bars. The crawfish was held in the container and a xenon/oxygen mixture was bubbled through the water using a recirculation pump that circulated gas from the headspace to the bottom of the chamber, from which the gas was permitted to bubble back into the headspace. The bubbling was performed for a 30 minute interval, followed by 30 minutes of no bubbling, etc, at 23° C. for 2.5 hours. After bubbling, the water was removed through a drain located at the bottom of the chamber. The chamber was again hermetically sealed and the atmosphere in the container was adjusted by introducing xenon up to 1.1 bars partial pressure and oxygen up to 0.3 bars partial pressure for a sum of xenon and oxygen partial pressures of 1.4 bars at a total pressure of 2.4 bars. The chamber containing the crawfish was placed in a heat-insulated container filled with ice and was cooled up to 6° C. The chamber was held for 20 hours under these conditions with temperature monitoring. The pressure in the container was then equilibrated with atmospheric pressure over a period of 30 minutes. The crawfish was removed and placed in a box (a non-hermetically closed container, without xenon). In order to provide humidity in the box, a piece of wet filter paper was included. The heart beat rate of the crawfish was monitored via cardiograph during the experiment. The heart beat rate of a control animal that was not subjected to a gas comprising xenon but was subjected to the same temperature changes as the experimental crawfish was monitored in the same way. The results of the experiment are as follows.

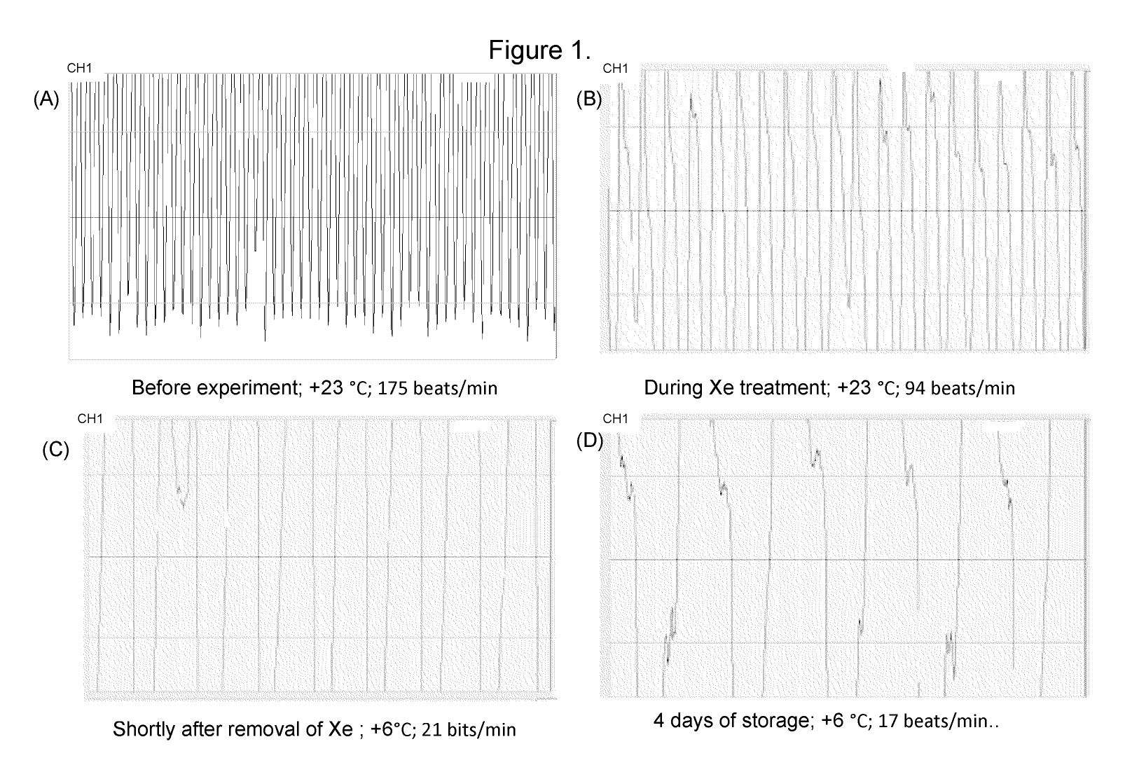

In the experimental crawfish (the crawfish treated with xenon), the heart beat rate was reduced as shown in FIG. 1. In particular, prior to performing the method, the crawfish heart beat rate was 175 beats per minute (at 23° C.). During the period in which the crawfish was held at 23° C. in the aqueous medium (at 23° C.), its heart beat rate fell to 94 beats per minute. Soon after holding the crawfish at 6° C. for 20 hours without the aqueous medium and removing the atmosphere comprising xenon from the container, the crawfish heart rate beat was 21 beats per minute. After 4 days at 6° C. without xenon, the crawfish heart rate beat was 17 beats per minute, thus demonstrating that the crawfish remained in the state of anabiosis after removal of the atmosphere comprising xenon from the container for at least 4 days. The crawfish was alive for 15 days at 6° C. without xenon during which time it had an average heart beat rate of 18 beats per minute.

A control crawfish not treated with the atmosphere comprising xenon and oxygen and held in a chamber with a wet filter paper at 23° C. was alive for three weeks, but a control crawfish not treated with the atmosphere comprising the xenon and oxygen and held in a chamber with a wet filter paper at 6° C. lived for only three days.

### EXAMPLE 2

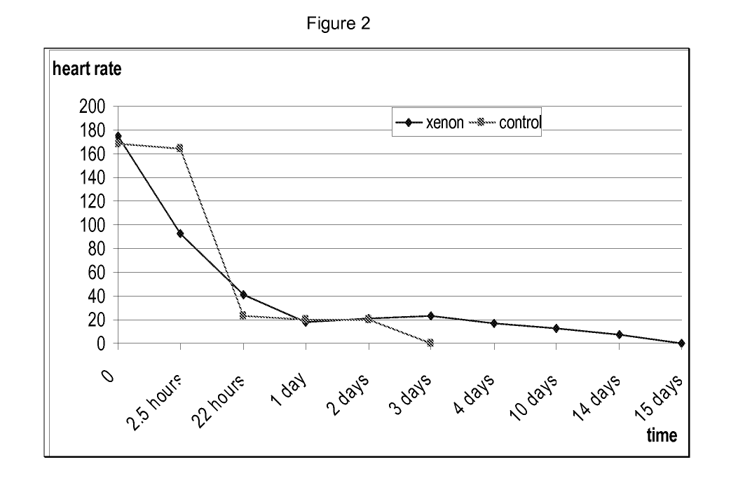

In order to test the method of the invention using a plurality of crawfish in a container, 8 crawfishes were brought into anabiosis as described in Example 1. Three groups of crawfishes containing 3, 3 and 2 crawfishes, were each placed into boxes having dimensions of 10×5×5 cm with wet filter paper, and refrigerated at 6° C. Their heart beat rate was recorded once a day as described for Example 1. As shown in FIG. 2, crawfish lived for between 11 and 16 days after entering into anabiosis. The average length of survival was 12.5 days. In contrast, a control crawfish that was not subjected to the above described procedure died in a refrigerator at 6° C. in 3 days.

### EXAMPLE 3

In order to analyze the effect of using the xenon and oxygen containing atmosphere in the container at higher pressures, an experiment was performed as described for Example 1, except that the atmosphere in the container was adjusted by introducing xenon up to 2.4 bars and oxygen up to 0.3 bars, for a total pressure of 2.7 bars. The atmosphere comprising the xenon and oxygen was bubbled at 23° C. for 2.5 hours, after which the water was removed from the container. After water was removed, the atmosphere in the container was adjusted by introducing xenon up to 2.4 bars and oxygen up to 0.3 bars for a total pressure of 2.7 bars. After 1 hour in this atmosphere, the crawfish' pulse became arythmic and bradycardia was observed. Thus, this Example demonstrates that subjecting a crawfish to an atmosphere comprising xenon at 2.4 bars and oxygen at 0.3 bars for a total pressure of 2.7 bars has a negative affect on the crawfish, even without cooling. Thus, such conditions inside a container are not suitable for causing a crawfish to enter anabiosis, and yet remain alive for a storage period according to the present invention. We also subjected crawfish using the same protocol to a partial pressure of 2.2 bars xenon/oxygen and determined that 2 bars is the maximum pressure that to which the partial pressures of oxygen and xenon can sum in order to facilitate the crawfish entry into a state of anabiosis.

We claim:

1. A method for preparing a live crustacean for storage, the method comprising:
i) causing the live crustacean to enter into an anesthetized state by exposing the crustacean to a combination of xenon and oxygen;
ii) cooling the anesthetized live crustacean to a temperature of from 1° C. to 10° C. to cause the crustacean to enter into a state of anabiosis; and
iii) storing the live crustacean in the state of anabiosis at 1° C. to 10° C. under from 90% to 100% humidity.

2. The method of claim 1, wherein during the causing the live crustacean to enter into an anesthetized state the live crustacean is partially or fully submerged in an aqueous medium contained in a container, wherein the container contains headspace comprising an atmosphere, and wherein the atmosphere comprises the combination of xenon and oxygen.

3. The method of claim 2, wherein partial pressure of the oxygen in the atmosphere is from 0.2 to 1 bar, wherein partial pressure of the xenon in the atmosphere is from 1 to 1.8 bars, and wherein the sum of the partial pressure of oxygen and the partial pressure of xenon in the atmosphere is from 1.2 to 2 bars.

4. The method of claim 1, wherein the combination of xenon and oxygen is circulated through the aqueous medium for a period of from one to six hours at ambient temperature.

5. The method of claim 4, wherein prior to, during, or after removing the aqueous medium from the container, the cooling of the anesthetized live crustacean to a temperature of 1° C. to 10° C. is performed in an atmosphere in the container adjusted such that partial pressure of the oxygen in the atmosphere is from 0.2 to 1 bar, partial pressure of the xenon in the atmosphere of the container is from 1 to 1.8 bars, and wherein the sum of the partial pressure of oxygen and the partial pressure of xenon in the atmosphere is from 1.2 to 2 bars.

6. The method of claim 5, wherein the live crustacean is held at the temperature of from 1° C. to 10° C. for a period of from three to 24 hours during which the crustacean enters into the state of anabiosis.

7. The method of claim 6, wherein subsequent to holding the live crustacean at the temperature of from 1° C. to 10° C. for the period of from three to 24 hours, pressure in the container is adjusted to ambient pressure.

8. The method of claim 7, wherein subsequent to adjusting the pressure in the container to ambient pressure, the live crustacean is stored in the state of anabiosis at 1° C. to 10° C. under from 90% to 100% humidity.

9. The method of claim 8, wherein the live crustacean is stored in a storage package, wherein the crustacean can survive in the storage package for at least four days.

10. The method of claim 9, wherein the live crustacean can survive in the storage package for at least fourteen days.

11. The method of claim 1, wherein the live crustacean is selected from the group consisting of crabs, lobsters, crawfish and shrimp, and combinations thereof.

12. The method of claim 11, wherein the live crustacean is a shrimp.

13. A container comprising a plurality of live crustaceans wherein the plurality of live crustaceans are present in a container containing an atmosphere comprising oxygen and xenon, wherein the temperature in the container is from 1-10° C., and wherein the plurality of live crustaceans are in a state of anabiosis.

14. The container of claim 13, wherein partial pressure of the oxygen in the atmosphere of the container is from 0.2 to 1 bar, wherein partial pressure of the xenon in the atmosphere of the container is from 1 to 1.8 bars, and wherein the sum of the partial pressure of oxygen and the partial pressure of xenon in the atmosphere of the container is from 1.2 to 2 bars

15. The container of claim 14, wherein the plurality of live crustaceans comprises crustaceans selected from the group consisting of crabs, lobsters, crawfish and shrimp, and combinations thereof.
